(19) United States
(12) Patent Application Publication
(10) Pub. No.: US 2026/0083617 A1
(43) Pub. Date: Mar. 26, 2026

(54) SLIDING ROD NESTING STRUCTURE

(71) Applicant: Zhejiang Red And Black Technology Co.,Ltd, Lishui (CN)

(72) Inventors: Xinyi Shu, Jinyun County (CN); Lifeng Shu, Jinyun County (CN)

(21) Appl. No.: 18/959,482

(22) Filed: Nov. 25, 2024

(30) Foreign Application Priority Data
Sep. 26, 2024 (CN) 2024223698750

(51) Int. Cl. A61H 7/00; F16C 29/02

(52) U.S. Cl. CPC A61H 7/00; F16C 29/02; A61H 2201/14

(57) ABSTRACT

A sliding rod nesting structure includes a sliding rod kit, a sliding rod insert, and a massage head, where the sliding rod insert is fixedly connected inside the sliding rod kit, and the massage head is connected to the sliding rod insert. The sliding rod kit is separated from the sliding rod insert. The sliding rod insert is made of plastic, which greatly facilitates the processing. Due to good plasticity and processability of the plastic, various complex connection structures are easy to process on the insert, so that processing costs are reduced. Because both the sliding rod insert and the massage head are made of the plastic, the sliding rod insert is more tightly connected to the massage head. Due to similar material properties, there is good sealing and fitting between contact surfaces of the sliding rod insert and the massage head.

### TECHNICAL FIELD

The present disclosure relates to a massage device, and in particular to a sliding rod nesting structure.

### BACKGROUND

In the conventional technologies, a sliding rod structure is widely used in various kinds of massage equipment, to implement functions such as sliding of components, positioning, and transmission of power.

The traditional sliding rod structure has disadvantages in processing difficulty, costs, selection of materials, and connection stability. Therefore, there is an urgent need for a new sliding rod structure to resolve the problems.

### SUMMARY

In view of this, it is necessary to provide a sliding rod nesting structure capable of resolving at least one of the above problems. The sliding rod nesting structure includes: a sliding rod kit, a sliding rod insert, and a massage head, where the sliding rod insert is fixedly connected inside the sliding rod kit, and the massage head is connected to the sliding rod insert.

Preferably, the massage head is connected to the sliding rod insert in a threaded manner.

Preferably, the sliding rod kit includes a shock-absorbing sleeve, a sliding sleeve, and a sliding rod holder, an annular adapting groove is provided in the shock-absorbing sleeve, the annular adapting groove is adapted to the sliding sleeve, and the sliding sleeve is sleeved on the sliding rod holder.

Preferably, a retention hole is provided on the sliding rod holder, the sliding sleeve includes a retention post, a threaded hole is provided on the retention post, and when the sliding sleeve is disposed on the sliding rod holder, the retention post is embedded in the retention hole.

Preferably, the sliding rod kit is made of metal.

Preferably, the sliding rod insert is made of plastic.

### BRIEF DESCRIPTION OF THE DRAWINGS

FIG. 1 is a schematic diagram of a structure of a sliding rod nesting structure according to an embodiment of the present disclosure;

FIG. 2 is an exploded view of a sliding rod nesting structure according to an embodiment of the present disclosure;

FIG. 3 is a profile of a sliding rod nesting structure according to an embodiment of the present disclosure;

FIG. 4 is an exploded view of a shock-absorbing sleeve and a sliding sleeve according to an embodiment of the present disclosure;

FIG. 5 is an exploded view of a sliding rod holder and a sliding rod insert according to an embodiment of the present disclosure; and

FIG. 6 is another exploded view of a sliding rod holder and a sliding rod insert according to an embodiment of the present disclosure.

Reference numerals: 1: sliding rod kit; 11: shock-absorbing sleeve; 111: annular adapting groove; 12: sliding sleeve; 13: sliding rod holder; 131: retention hole; 2: sliding rod insert; 21: retention post; 211: threaded hole; 3: massage head.

### DETAILED DESCRIPTION OF THE EMBODIMENTS

To make the objectives, technical solutions and the advantages of the present disclosure clearer, the sliding rod nesting structure provided in the present disclosure is described in further detail below with reference to the drawings and embodiments. Understandably, the described embodiments are merely intended to explain the present disclosure, rather than to limit the present disclosure.

It should be understood that in the description of the present disclosure, unless otherwise specified, “a plurality of” means two or more; and terms such as “central”, “longitudinal”, “transverse”, “upper”, “lower”, “left”, “right”, “inside”, “outside”, “front”, “rear”, “head”, “tail”, “vertical”, “horizontal”, “top”, and “bottom” indicate the orientation or position relationships based on the drawings. They are merely intended to facilitate and simplify the description of the present disclosure, rather than to indicate or imply that the mentioned device or components must have a specific orientation or must be constructed and operated in a specific orientation. Therefore, these terms should not be construed as a limitation to the present disclosure. Moreover, the terms “first”, “second”, and “third” are merely used for description, and are not intended to indicate or imply relative importance.

In the description of the present disclosure, it should be noted that, unless otherwise clearly specified, meanings of terms “install”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation.

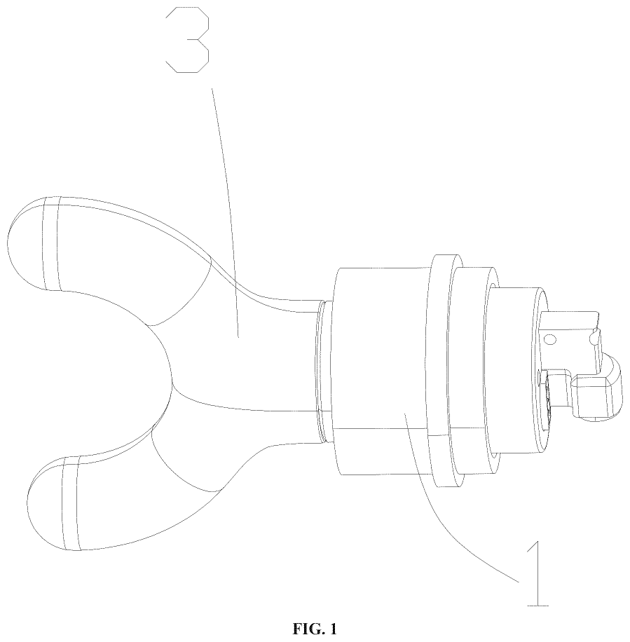

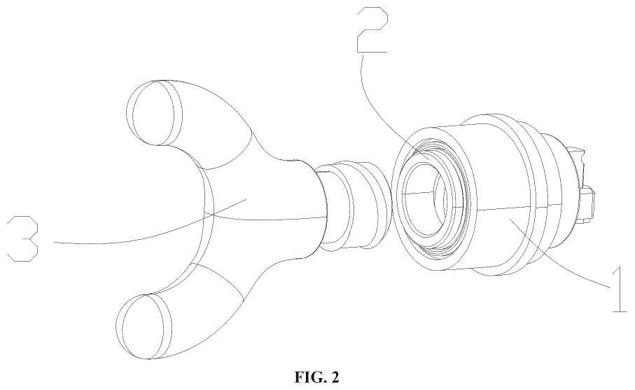

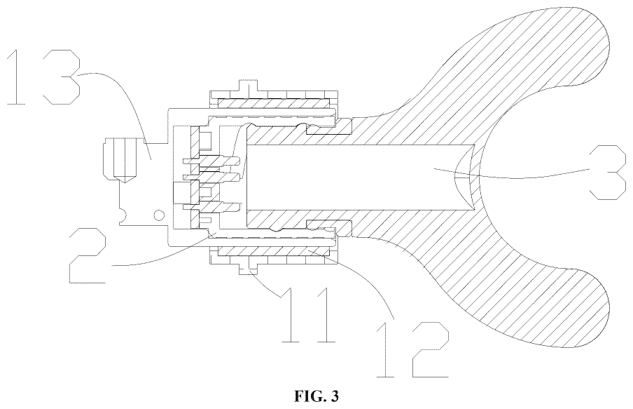

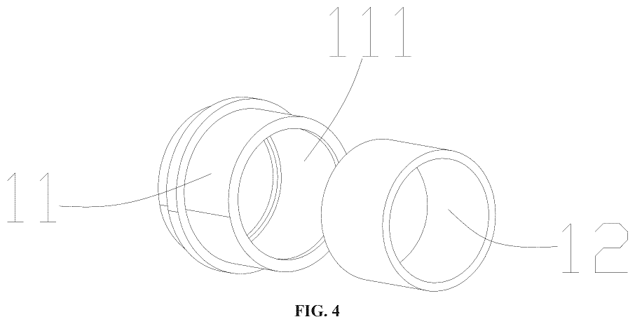

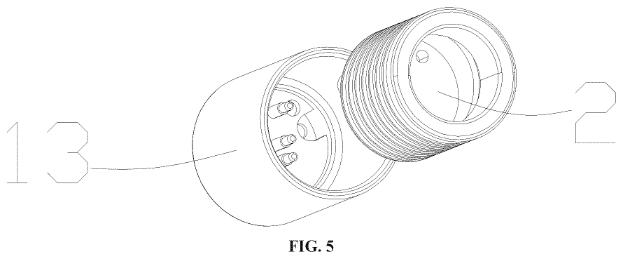

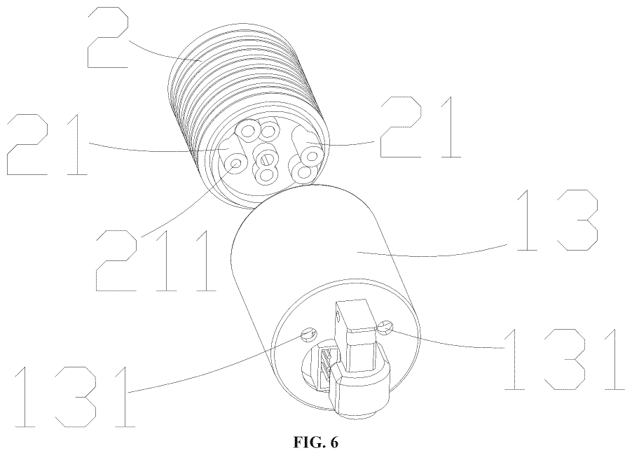

Referring to FIG. 1 to FIG. 6, a sliding rod nesting structure provided in the embodiments of the present disclosure includes a sliding rod kit 1, a sliding rod insert 2, and a massage head 3. The sliding rod insert 2 is fixedly connected inside the sliding rod kit 1, and the massage head 3 is coaxially and detachably connected to the sliding rod insert 2, preferably, connected in a threaded manner, which is not limited herein.

In this embodiment, the sliding rod kit 1 is separated from the sliding rod insert 2. The sliding rod insert 2 is made of plastic, which greatly facilitates the processing. Due to good plasticity and processability of the plastic, various complex connection structures are easy to process on the insert, so that processing costs are reduced.

Further, because both the sliding rod insert 2 and the massage head 3 are made of the plastic, the sliding rod insert 2 is more tightly connected to the massage head 3. Due to similar material properties, there is good sealing and fitting between contact surfaces of the sliding rod insert 2 and the massage head 3. Therefore, problems of a gap and loosening caused by a difference between materials are resolved. Because of the tight connection, the overall stability of a massage device is improved, and forces are uniformly transmitted during a massage process. This provides users with more comfortable and effective massage experience.

In addition, although the sliding rod insert 2 is made of the plastic, the sliding rod kit 1 is made of metal, so that the overall strength of the sliding rod nesting structure is ensured. Due to high strength and corrosion resistance of the metal, the sliding rod kit 1 is able to withstand various forces during the massage process, and is not easily damaged. This ensures the long-term performance and safety of the massage device.

In conclusion, the design of the sliding rod nesting structure ensures the tightness of the connection and the strength of the structure while processing is easy to perform and costs are reduced.

Referring to FIG. 1 to FIG. 6, in another embodiment, the massage head 3 is connected to the sliding rod insert 2 in a threaded manner.

In this embodiment, the massage head 3 is designed with an internal thread, while an end of the sliding rod insert 2 is machined with an external thread matching the internal thread. When the massage head 3 is screwed into the sliding rod insert 2, the internal thread is tightly engaged with the external thread, to form a firm connection. This connection is simple and reliable, and facilitates the removal and replacement of the massage head 3, thereby improving the maintenance and flexibility of the massage device.

Referring to FIG. 1 to FIG. 6, in another embodiment, the sliding rod kit 1 includes a shock-absorbing sleeve 11, a sliding sleeve 12, and a sliding rod holder 13. An annular adapting groove 111 is provided in the shock-absorbing sleeve 11, the annular adapting groove 111 is adapted to the sliding sleeve 12, and the sliding sleeve 12 is sleeved on the sliding rod holder 13.

In this embodiment, the annular adapting groove 111 is provided in the shock-absorbing sleeve 11, a shape and size of the annular adapting groove 111 accurately matching an outer contour of the sliding sleeve 12, to ensure that the annular adapting groove 111 is tightly attached to the shock-absorbing sleeve 11. The sliding sleeve 12 is further sleeved on the sliding rod holder 13, to implement a relative movement with the holder in a sliding fit manner. This nesting design enhances the integrity of the sliding rod nesting structure, and effectively absorbs, by means of the shock-absorbing sleeve 11, the vibration and impact that may occur during the massage process. Therefore, the comfort of the use of users is enhanced. In addition, the sliding sleeve 12 is connected to the sliding rod holder 13 in a sliding manner, to provide a smooth sliding track for the massage head 3. This ensures the flexibility and accuracy of a massage action.

Referring to FIG. 1 to FIG. 6, in another embodiment, a retention hole 131 is provided on the sliding rod holder 13. The sliding sleeve 12 includes a retention post 21, and a threaded hole 211 is provided on the retention post 21. When the sliding sleeve 12 is disposed on the sliding rod holder 13, the retention post 21 is embedded in the retention hole 131.

In this embodiment, the sliding sleeve 12 includes the retention post 21, and a threaded hole 211 is provided on the retention post 21, to matching a fastener (for example, a screw). When the sliding sleeve 12 is mounted to the sliding rod holder 13, the retention post 21 is accurately aligned to and embedded in the retention hole 131, to form an initial axial positioning. Subsequently, the sliding sleeve 12 is firmly connected to the sliding rod holder 13 by screwing the fastener into the sliding rod holder 13 or a corresponding retention structure after the fastener passes through the threaded hole 211 of the sliding sleeve 12. This design simplifies a mounting process, and ensures the stability and reliability of the sliding sleeve 12 on the sliding rod holder 13, to provide a solid foundation for the smooth sliding of the massage head 3.

Referring to FIG. 1 to FIG. 6, in another embodiment, the sliding rod kit 1 is made of metal. The sliding rod insert 2 is made of plastic.

In this embodiment, specifically, the sliding rod kit 1 is made of the metal, and utilizes high strength, corrosion resistance and good thermal conductivity of the metal to provide a stable support framework and a durable foundation for the sliding rod nesting structure. The metal material ensures that the sliding rod kit 1 is not easy to deform or damage when bearing the various forces in the massage process, thereby ensuring long-term usability of the massage device.

Correspondingly, the sliding rod insert 2 is made of the plastic. The plastic has good processability, a lightweight, and cost-effectiveness. This facilitates to process complex connection structures and details on the inserts.

The above embodiments are only preferred ones of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

What is claimed is:

1. A sliding rod nesting structure, comprising a sliding rod kit, a sliding rod insert, and a massage head, wherein the sliding rod insert is fixedly connected inside the sliding rod kit, and the massage head is connected to the sliding rod insert.

2. The sliding rod nesting structure according to claim 1, wherein the massage head is connected to the sliding rod insert in a threaded manner.

3. The sliding rod nesting structure according to claim 1, wherein the sliding rod kit comprises a shock-absorbing sleeve, a sliding sleeve, and a sliding rod holder, an annular adapting groove is provided in the shock-absorbing sleeve, the annular adapting groove is adapted to the sliding sleeve, and the sliding sleeve is sleeved on the sliding rod holder.

4. The sliding rod nesting structure according to claim 3, wherein a retention hole is provided on the sliding rod holder, the sliding sleeve comprises a retention post, a threaded hole is provided on the retention post, and when the sliding sleeve is disposed on the sliding rod holder, the retention post is embedded in the retention hole.

5. The sliding rod nesting structure according to claim 1, wherein the sliding rod kit is made of metal.

6. The sliding rod nesting structure according to claim 1, wherein the sliding rod insert is made of plastic.
